(19) United States
(12) Patent Application Publication
(10) Pub. No.: US 2022/0357968 A1
(43) Pub. Date: Nov. 10, 2022

(54) Heuristic Policy Recommendations in a Virtual Environment

(71) Applicant: Citrix Systems, Inc., Fort Lauderdale, FL (US)

(72) Inventor: Priyanka S, Bangalore (IN)

(21) Appl. No.: 17/314,472

(22) Filed: May 7, 2021

(51) Int. Cl. G06F 9/455; H04L 12/24; H04L 29/06

(52) U.S. Cl. CPC G06F 9/45558; H04L 41/0883; H04L 41/0893; H04L 65/80; G06F 2009/45562; G06F 2009/45587

(57) ABSTRACT

Methods and systems for heuristic and automated policy recommendations in a virtual environment are described herein. A computing device may obtain, from a plurality of user devices, usage information associated with a virtual service. The computing device may obtain, from the plurality of user devices, currently applied user experience policies for the virtual service. The computing device may further obtain, from the plurality of user devices, system settings for the virtual service. Based on the usage information, the currently applied user experience policies, and the system settings, the computing device may cluster users associated with the plurality of user devices into user groups; and determine a set of new policies for each user group. The computing device may further recommend the set of the new policies.

### FIELD

Aspects described herein generally relate to computer networking, remote computer access, cloud computing systems, and hardware and software related thereto. More specifically, one or more aspects describe herein provide heuristic and automated recommendations for adapting a virtual environment to improve security, workflow, and/or user experience.

### BACKGROUND

User experiences in a virtual environment may be greatly affected by the policies set by the system administrators. For example, graphic policies applied on a user application may affect how images and videos are delivered and presented in user sessions. Given the complexity and the overwhelming number of available policy configurations, it is challenging to properly and efficiently configure policies for users in a virtual environment. The policy configurations may be driven by the way a remote system is used. The system may require system administrators or technicians to have a considerable amount of technology stack understanding to configure the right policies for each user. Complete manual configuration of policies may be impractical or inefficient. Thus, there remains a need to improve and simplify the policy configuration process in a virtual environment.

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

To overcome limitations described above, and to overcome other limitations that will be apparent upon reading and understanding the present specification, aspects described herein are directed towards heuristic policy recommendations in a virtual environment.

In an illustrative embodiment, a method may be provided for heuristic and automated policy recommendations in a virtual environment. In an illustrative method, a computing device may obtain, from a plurality of user devices, usage information associated with a virtual service. The computing device may obtain, from the plurality of user devices, currently applied user experience policies for the virtual service. The computing device may further obtain, from the plurality of user devices, system settings for the virtual service. Based on the usage information, the currently applied user experience policies, and the system settings, the computing device may cluster users associated with the plurality of user devices into user groups; and determine a set of new policies for each user group. The computing device may further recommend the set of the new policies.

In an embodiment of the present disclosure, an apparatus may be provided for heuristic and automated policy recommendations in a virtual environment. The apparatus comprises one or more processors; and memory storing instructions that, when executed by the one or more processors, cause the apparatus to obtain, from a plurality of user devices, usage information associated with a virtual service. The instructions may further cause the apparatus to obtain, from the plurality of user devices, currently applied user experience policies for the virtual service. The instructions may further cause the apparatus to obtain, from the plurality of user devices, system settings for the virtual service. Based on the usage information, the currently applied user experience policies, and the system settings, the instructions may further cause the apparatus to cluster users associated with the plurality of user devices into user groups; and determine a set of new policies for each user group. The instructions may further cause the apparatus to recommend the set of the new policies.

In an embodiment of the present disclosure, one or more non-transitory computer readable media may be provided to perform one or more of the processes described herein.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIG. 3 depicts an illustrative virtualized system architecture that may be used in accordance with one or more illustrative aspects described herein.

FIG. 4 depicts an illustrative cloud-based system architecture that may be used in accordance with one or more illustrative aspects described herein.

FIG. 5A is a block diagram of an example system in which resource management services may manage and streamline access by clients to resource feeds (via one or more gateway services) and/or software-as-a-service (SaaS) applications.

FIG. 5B is a block diagram showing an example implementation of the system shown in FIG. 5A in which various resource management services as well as a gateway service are located within a cloud computing environment.

FIG. 6 depicts a schematic diagram showing an example system for obtaining user experience information that may be used in accordance with one or more illustrative aspects described herein.

FIG. 7 depicts a schematic diagram showing an example system for providing heuristic and automated policy recommendations in a virtual environment that may be used in accordance with one or more illustrative aspects described herein.

FIGS. 8A and 8B depict a flowchart showing an example method for providing heuristic and automated policy recommendations in a virtual environment that may be used in accordance with one or more illustrative aspects described herein.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “connected,” “coupled,” and similar terms, is meant to include both direct and indirect mounting, connecting, coupling, positioning and engaging.

Computing Architecture

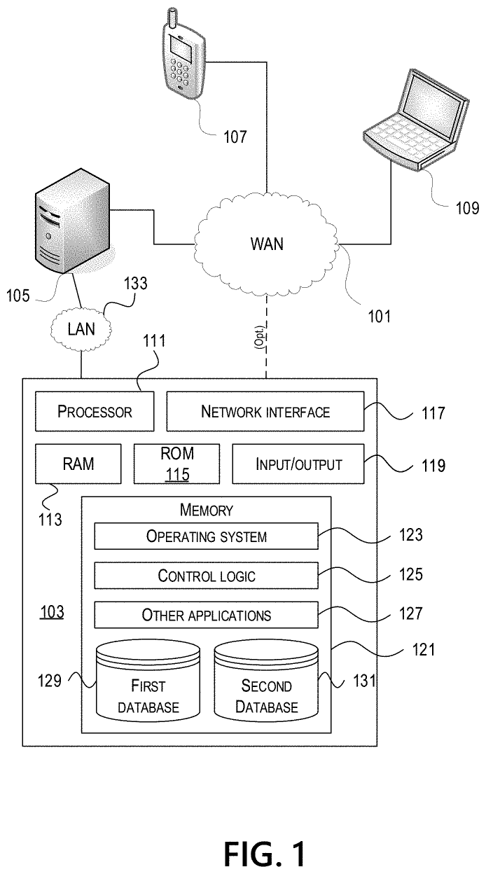

Computer software, hardware, and networks may be utilized in a variety of different system environments, including standalone, networked, remote-access (also known as remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, web server 105, and client computers 107, 109. Data server 103 provides overall access, control and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through local area network 133, wide area network 101 (e.g., the Internet), via direct or indirect connection, or via some other network. Users may interact with the data server 103 using remote computers 107, 109, e.g., using a web browser to connect to data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling overall operation of data processing device 103, control logic 125 for instructing data server 103 to perform aspects described herein, and other application software 127 providing secondary, support, and/or other functionality which may or might not be used in conjunction with aspects described herein. Control logic 125 may also be referred to herein as data server software 125. Functionality of data server software 125 may refer to operations or decisions made automatically based on rules coded into control logic 125, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, first database 129 may include second database 131 (e.g., as a separate table, report, etc.). That is, the information can be stored in a single database, or separated into different logical, virtual, or physical databases, depending on system design. Devices 105, 107, and 109 may have similar or different architecture as described with respect to device 103. Those of skill in the art will appreciate that the functionality of data processing device 103 (or device 105, 107, or 109) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, solid state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

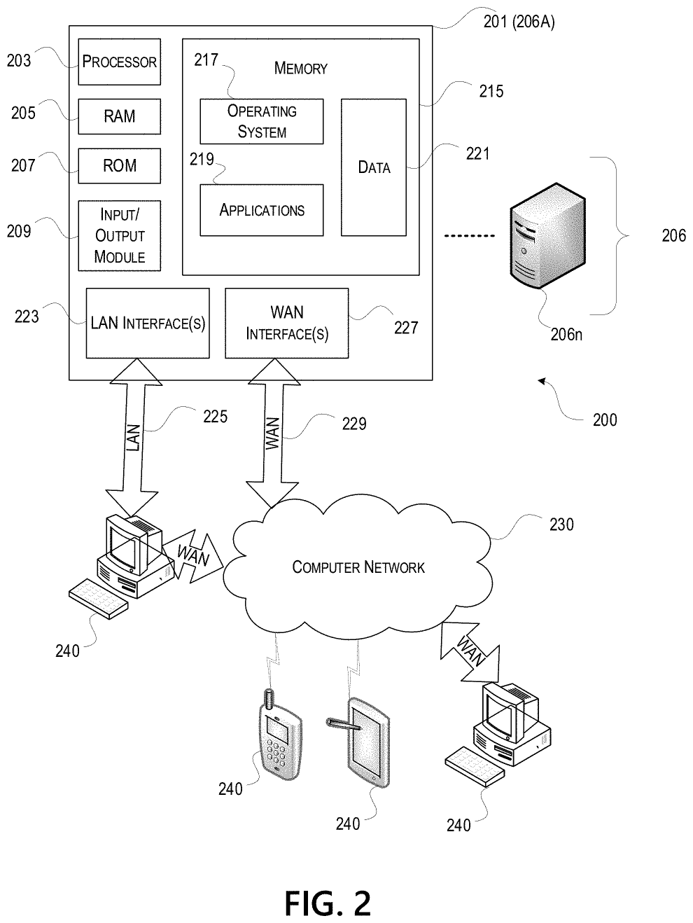

With further reference to FIG. 2, one or more aspects described herein may be implemented in a remote-access environment. FIG. 2 depicts an example system architecture including a computing device 201 in an illustrative computing environment 200 that may be used according to one or more illustrative aspects described herein. Computing device 201 may be used as a server 206a in a single-server or multi-server desktop virtualization system (e.g., a remote access or cloud system) and can be configured to provide virtual machines for client access devices. Computing device 201 may have a processor 203 for controlling overall operation of computing device 201 and its associated components, including RAM 205, ROM 207, Input/Output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by computing device 201, such as an operating system 217, application programs 219, and an associated database 221.

Computing device 201 may operate in a networked environment supporting connections to one or more remote computers, such as terminals 240 (also referred to as client devices and/or client machines). Terminals 240 may be personal computers, mobile devices, laptop computers, tablets, or servers that include many or all of the elements described above with respect to computing device 103 or 201. The network connections depicted in FIG. 2 include a local area network (LAN) 225 and a wide area network (WAN) 229, but may also include other networks. When used in a LAN networking environment, computing device 201 may be connected to LAN 225 through a network interface or adapter 223. When used in a WAN networking environment, computing device 201 may include a modem or other wide area network interface 227 for establishing communications over the WAN 229, such as computer network 230 (e.g., the Internet). It will be appreciated that the network connections shown are illustrative and other means of establishing a communications link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more client devices 240 may be in communication with one or more servers 206a-206n (generally referred to herein as “server(s) 206”). In one embodiment, the computing environment 200 may include a network appliance installed between server(s) 206 and client machine(s) 240. The network appliance may manage client/server connections, and in some cases can load balance client connections amongst a plurality of backend servers 206.

The client machine(s) 240 may in some embodiments be referred to as a single client machine 240 or a single group of client machines 240, while server(s) 206 may be referred to as a single server 206 or a single group of servers 206. In one embodiment a single client machine 240 communicates with more than one server 206, while in another embodiment a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); client computer(s); client device(s); client computing device(s); local machine; remote machine; client node(s); endpoint(s); or endpoint node(s). The server 206, in some embodiments, may be referenced by any one of the following non-exhaustive terms: server(s), local machine; remote machine; server farm(s), or host computing device(s).

In one embodiment, client machine 240 may be a virtual machine. The virtual machine may be any virtual machine, while in some embodiments the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects the virtual machine may be managed by a hypervisor executing on a server 206 or a hypervisor executing on a client 240.

Some embodiments include a client device 240 that displays application output generated by an application remotely executing on a server 206 or other remotely located machine. In these embodiments, client device 240 may execute a virtual machine receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

Server 206, in some embodiments, uses a remote presentation protocol or other program to send data to a thin-client or remote-display application executing on the client to present display output generated by an application executing on server 206. The thin-client or remote-display protocol can be any one of the following non-exhaustive list of protocols: the Independent Computing Architecture (ICA) protocol developed by Citrix Systems, Inc. of Ft. Lauderdale, Fla.; or the Remote Desktop Protocol (RDP) manufactured by the Microsoft Corporation of Redmond, Wash.

A remote computing environment may include more than one server 206a-206n such that the servers 206a-206n are logically grouped together into a server farm 206, for example, in a cloud computing environment. Server farm 206 may include servers 206 that are geographically dispersed while logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments server farm 206 may be administered as a single entity, while in other embodiments server farm 206 can include multiple server farms.

In some embodiments, a server farm may include servers 206 that execute a substantially similar type of operating system platform (e.g., WINDOWS, UNIX, LINUX, iOS, ANDROID, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

Some embodiments include a first server 206a that receives requests from a client machine 240, forwards the request to a second server 206b (not shown), and responds to the request generated by client machine 240 with a response from second server 206b (not shown.) First server 206a may acquire an enumeration of applications available to client machine 240 as well as address information associated with an application server 206 hosting an application identified within the enumeration of applications. First server 206a can then present a response to the client's request using a web interface, and communicate directly with client 240 to provide client 240 with access to an identified application. One or more clients 240 and/or one or more servers 206 may transmit data over network 230, e.g., network 101.

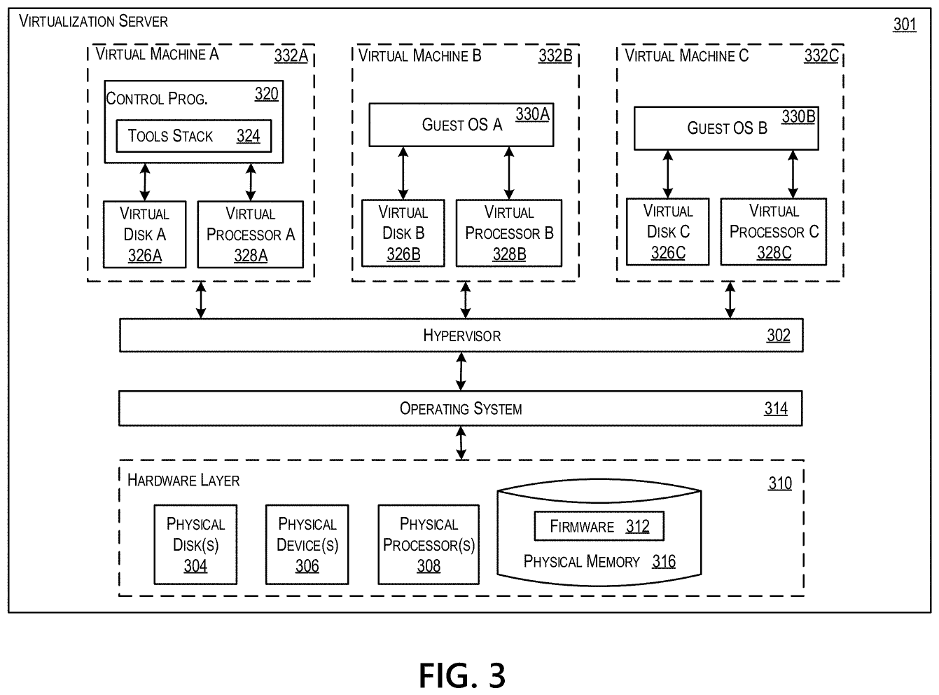

FIG. 3 shows a high-level architecture of an illustrative desktop virtualization system. As shown, the desktop virtualization system may be single-server or multi-server system, or cloud system, including at least one virtualization server 301 configured to provide virtual desktops and/or virtual applications to one or more client access devices 240. As used herein, a desktop refers to a graphical environment or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per device) or virtual (e.g., many instances of an OS running on a single device). Each application may be executed on a local device, or executed on a remotely located device (e.g., remoted).

A computer device 301 may be configured as a virtualization server in a virtualization environment, for example, a single-server, multi-server, or cloud computing environment. Virtualization server 301 illustrated in FIG. 3 can be deployed as and/or implemented by one or more embodiments of server 206 illustrated in FIG. 2 or by other known computing devices. Included in virtualization server 301 is a hardware layer that can include one or more physical disks 304, one or more physical devices 306, one or more physical processors 308, and one or more physical memories 316. In some embodiments, firmware 312 can be stored within a memory element in physical memory 316 and can be executed by one or more of physical processors 308. Virtualization server 301 may further include an operating system 314 that may be stored in a memory element in physical memory 316 and executed by one or more of physical processors 308. Still further, a hypervisor 302 may be stored in a memory element in physical memory 316 and can be executed by one or more of physical processors 308.

Executing on one or more of physical processors 308 may be one or more virtual machines 332A-C (generally 332). Each virtual machine 332 may have a virtual disk 326A-C and a virtual processor 328A-C. In some embodiments, a first virtual machine 332A may execute, using a virtual processor 328A, a control program 320 that includes a tools stack 324. Control program 320 may be referred to as a control virtual machine, Dom0, Domain 0, or other virtual machine used for system administration and/or control. In some embodiments, one or more virtual machines 332B-C can execute, using a virtual processor 328B-C, a guest operating system 330A-B.

Virtualization server 301 may include a hardware layer 310 with one or more pieces of hardware that communicate with the virtualization server 301. In some embodiments, hardware layer 310 can include one or more physical disks 304, one or more physical devices 306, one or more physical processors 308, and one or more physical memory 316. Physical components 304, 306, 308, and 316 may include, for example, any of the components described above. Physical devices 306 may include, for example, a network interface card, a video card, a keyboard, a mouse, an input device, a monitor, a display device, speakers, an optical drive, a storage device, a universal serial bus connection, a printer, a scanner, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in hardware layer 310 may include any type of memory. Physical memory 316 may store data, and in some embodiments may store one or more programs, or set of executable instructions. FIG. 3 illustrates an embodiment where firmware 312 is stored within physical memory 316 of virtualization server 301. Programs or executable instructions stored in physical memory 316 can be executed by one or more processors 308 of virtualization server 301.

Virtualization server 301 may also include a hypervisor 302. In some embodiments, hypervisor 302 may be a program executed by processors 308 on virtualization server 301 to create and manage any number of virtual machines 332. Hypervisor 302 may be referred to as a virtual machine monitor, or platform virtualization software. In some embodiments, hypervisor 302 can be any combination of executable instructions and hardware that monitors virtual machines executing on a computing machine. Hypervisor 302 may be Type 2 hypervisor, where the hypervisor executes within an operating system 314 executing on virtualization server 301. Virtual machines may then execute at a level above hypervisor 302. In some embodiments, the Type 2 hypervisor may execute within the context of a user's operating system such that the Type 2 hypervisor interacts with the user's operating system. In other embodiments, one or more virtualization servers 301 in a virtualization environment may instead include a Type 1 hypervisor (not shown). A Type 1 hypervisor may execute on virtualization server 301 by directly accessing the hardware and resources within the hardware layer 310. That is, while a Type 2 hypervisor 302 accesses system resources through a host operating system 314, as shown, a Type 1 hypervisor may directly access all system resources without host operating system 314. A Type 1 hypervisor may execute directly on one or more physical processors 308 of virtualization server 301, and may include program data stored in physical memory 316.

Hypervisor 302, in some embodiments, can provide virtual resources to operating systems 330 or control programs 320 executing on virtual machines 332 in any manner that simulates operating systems 330 or control programs 320 having direct access to system resources. System resources can include, but are not limited to, physical devices 306, physical disks 304, physical processors 308, physical memory 316, and any other component included in hardware layer 310 of virtualization server 301. Hypervisor 302 may be used to emulate virtual hardware, partition physical hardware, virtualize physical hardware, and/or execute virtual machines that provide access to computing environments. In still other embodiments, hypervisor 302 may control processor scheduling and memory partitioning for a virtual machine 332 executing on virtualization server 301. Hypervisor 302 may include those manufactured by VMWare, Inc., of Palo Alto, Calif.; HyperV, VirtualServer or virtual PC hypervisors provided by Microsoft, or others. In some embodiments, virtualization server 301 may execute a hypervisor 302 that creates a virtual machine platform on which guest operating systems may execute. In these embodiments, virtualization server 301 may be referred to as a host server. An example of such a virtualization server is the Citrix Hypervisor provided by Citrix Systems, Inc., of Fort Lauderdale, Fla.

Hypervisor 302 may create one or more virtual machines 332B-C (generally 332) in which guest operating systems 330 execute. In some embodiments, hypervisor 302 may load a virtual machine image to create a virtual machine 332. In other embodiments, hypervisor 302 may execute a guest operating system 330 within virtual machine 332. In still other embodiments, virtual machine 332 may execute guest operating system 330.

In addition to creating virtual machines 332, hypervisor 302 may control the execution of at least one virtual machine 332. In other embodiments, hypervisor 302 may present at least one virtual machine 332 with an abstraction of at least one hardware resource provided by virtualization server 301 (e.g., any hardware resource available within the hardware layer 310). In other embodiments, hypervisor 302 may control the manner in which virtual machines 332 access physical processors 308 available in virtualization server 301. Controlling access to physical processors 308 may include determining whether a virtual machine 332 should have access to a processor 308, and how physical processor capabilities are presented to virtual machine 332.

As shown in FIG. 3, virtualization server 301 may host or execute one or more virtual machines 332. A virtual machine 332 is a set of executable instructions that, when executed by a processor 308, may imitate the operation of a physical computer such that virtual machine 332 can execute programs and processes much like a physical computing device. While FIG. 3 illustrates an embodiment where a virtualization server 301 hosts three virtual machines 332, in other embodiments virtualization server 301 can host any number of virtual machines 332. Hypervisor 302, in some embodiments, may provide each virtual machine 332 with a unique virtual view of the physical hardware, memory, processor, and other system resources available to that virtual machine 332. In some embodiments, the unique virtual view can be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 302 may create one or more unsecure virtual machines 332 and one or more secure virtual machines 332. Unsecure virtual machines 332 may be prevented from accessing resources, hardware, memory locations, and programs that secure virtual machines 332 may be permitted to access. In other embodiments, hypervisor 302 may provide each virtual machine 332 with a substantially similar virtual view of the physical hardware, memory, processor, and other system resources available to virtual machines 332.

Each virtual machine 332 may include a virtual disk 326A-C (generally 326) and a virtual processor 328A-C (generally 328.) Virtual disk 326, in some embodiments, is a virtualized view of one or more physical disks 304 of virtualization server 301, or a portion of one or more physical disks 304 of virtualization server 301. The virtualized view of physical disks 304 can be generated, provided, and managed by hypervisor 302. In some embodiments, hypervisor 302 provides each virtual machine 332 with a unique view of the physical disks 304. Thus, in these embodiments, particular virtual disk 326 included in each virtual machine 332 can be unique when compared with other virtual disks 326.

A virtual processor 328 can be a virtualized view of one or more physical processors 308 of virtualization server 301. In some embodiments, the virtualized view of physical processors 308 can be generated, provided, and managed by hypervisor 302. In some embodiments, virtual processor 328 has substantially all of the same characteristics of at least one physical processor 308. In other embodiments, virtual processor 308 provides a modified view of physical processors 308 such that at least some of the characteristics of virtual processor 328 are different than the characteristics of the corresponding physical processor 308.

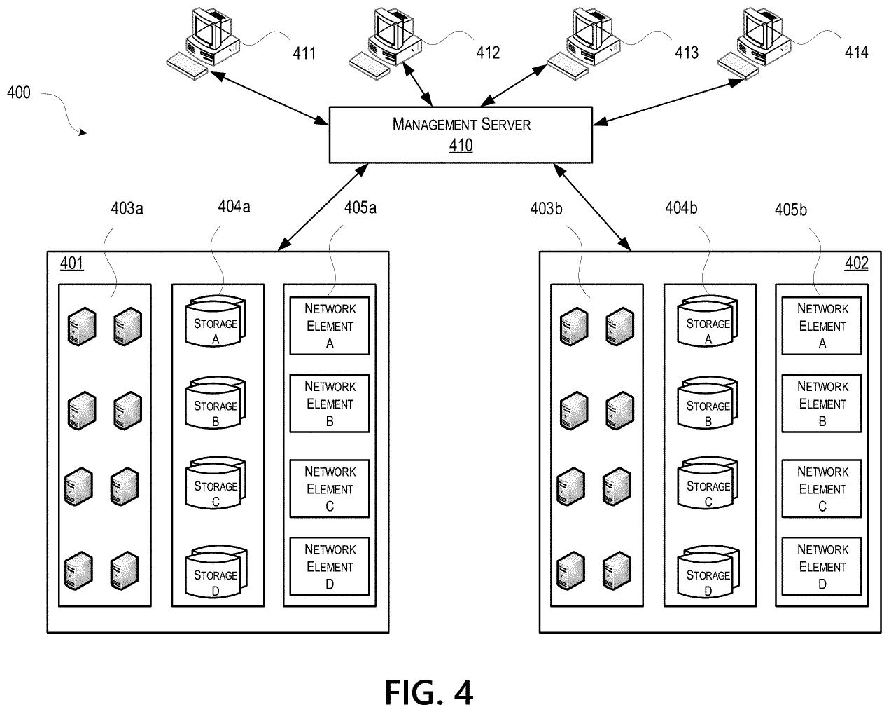

With further reference to FIG. 4, some aspects described herein may be implemented in a cloud-based environment. FIG. 4 illustrates an example of a cloud computing environment (or cloud system) 400. As seen in FIG. 4, client computers 411-414 may communicate with a cloud management server 410 to access the computing resources (e.g., host servers 403a-403b (generally referred herein as “host servers 403”), storage resources 404a-404b (generally referred herein as “storage resources 404”), and network elements 405a-405b (generally referred herein as “network resources 405”)) of the cloud system.

Management server 410 may be implemented on one or more physical servers. The management server 410 may run, for example, Citrix Cloud by Citrix Systems, Inc. of Ft. Lauderdale, Fla., or OPENSTACK, among others. Management server 410 may manage various computing resources, including cloud hardware and software resources, for example, host computers 403, data storage devices 404, and networking devices 405. The cloud hardware and software resources may include private and/or public components. For example, a cloud may be configured as a private cloud to be used by one or more particular customers or client computers 411-414 and/or over a private network. In other embodiments, public clouds or hybrid public-private clouds may be used by other customers over an open or hybrid networks.

Management server 410 may be configured to provide user interfaces through which cloud operators and cloud customers may interact with the cloud system 400. For example, management server 410 may provide a set of application programming interfaces (APIs) and/or one or more cloud operator console applications (e.g., web-based or standalone applications) with user interfaces to allow cloud operators to manage the cloud resources, configure the virtualization layer, manage customer accounts, and perform other cloud administration tasks. Management server 410 also may include a set of APIs and/or one or more customer console applications with user interfaces configured to receive cloud computing requests from end users via client computers 411-414, for example, requests to create, modify, or destroy virtual machines within the cloud. Client computers 411-414 may connect to management server 410 via the Internet or some other communication network, and may request access to one or more of the computing resources managed by management server 410. In response to client requests, management server 410 may include a resource manager configured to select and provision physical resources in the hardware layer of the cloud system based on the client requests. For example, management server 410 and additional components of the cloud system may be configured to provision, create, and manage virtual machines and their operating environments (e.g., hypervisors, storage resources, services offered by the network elements, etc.) for customers at client computers 411-414, over a network (e.g., the Internet), providing customers with computational resources, data storage services, networking capabilities, and computer platform and application support. Cloud systems also may be configured to provide various specific services, including security systems, development environments, user interfaces, and the like.

Certain clients 411-414 may be related, for example, to different client computers creating virtual machines on behalf of the same end user, or different users affiliated with the same company or organization. In other examples, certain clients 411-414 may be unrelated, such as users affiliated with different companies or organizations. For unrelated clients, information on the virtual machines or storage of any one user may be hidden from other users.

Referring now to the physical hardware layer of a cloud computing environment, availability zones 401-402 (or zones) may refer to a collocated set of physical computing resources. Zones may be geographically separated from other zones in the overall cloud of computing resources. For example, zone 401 may be a first cloud datacenter located in California, and zone 402 may be a second cloud datacenter located in Florida. Management server 410 may be located at one of the availability zones, or at a separate location. Each zone may include an internal network that interfaces with devices that are outside of the zone, such as the management server 410, through a gateway. End users of the cloud (e.g., clients 411-414) might or might not be aware of the distinctions between zones. For example, an end user may request the creation of a virtual machine having a specified amount of memory, processing power, and network capabilities. Management server 410 may respond to the user's request and may allocate the resources to create the virtual machine without the user knowing whether the virtual machine was created using resources from zone 401 or zone 402. In other examples, the cloud system may allow end users to request that virtual machines (or other cloud resources) are allocated in a specific zone or on specific resources 403-405 within a zone.

In this example, each zone 401-402 may include an arrangement of various physical hardware components (or computing resources) 403-405, for example, physical hosting resources (or processing resources), physical network resources, physical storage resources, switches, and additional hardware resources that may be used to provide cloud computing services to customers. The physical hosting resources in a cloud zone 401-402 may include one or more computer servers 403, such as the virtualization servers 301 described above, which may be configured to create and host virtual machine instances. The physical network resources in a cloud zone 401 or 402 may include one or more network elements 405 (e.g., network service providers) comprising hardware and/or software configured to provide a network service to cloud customers, such as firewalls, network address translators, load balancers, virtual private network (VPN) gateways, Dynamic Host Configuration Protocol (DHCP) routers, and the like. The storage resources in the cloud zone 401-402 may include storage disks (e.g., solid state drives (SSDs), magnetic hard disks, etc.) and other storage devices.

The example cloud computing environment shown in FIG. 4 also may include a virtualization layer (e.g., as shown in FIGS. 1-3) with additional hardware and/or software resources configured to create and manage virtual machines and provide other services to customers using the physical resources in the cloud. The virtualization layer may include hypervisors, as described above in FIG. 3, along with other components to provide network virtualizations, storage virtualizations, etc. The virtualization layer may be as a separate layer from the physical resource layer, or may share some or all of the same hardware and/or software resources with the physical resource layer. For example, the virtualization layer may include a hypervisor installed in each of the virtualization servers 403 with the physical computing resources. Known cloud systems may alternatively be used, e.g., WINDOWS AZURE (Microsoft Corporation of Redmond Wash.), AMAZON EC2 (Amazon.com Inc. of Seattle, Wash.), IBM BLUE CLOUD (IBM Corporation of Armonk, N.Y.), or others.

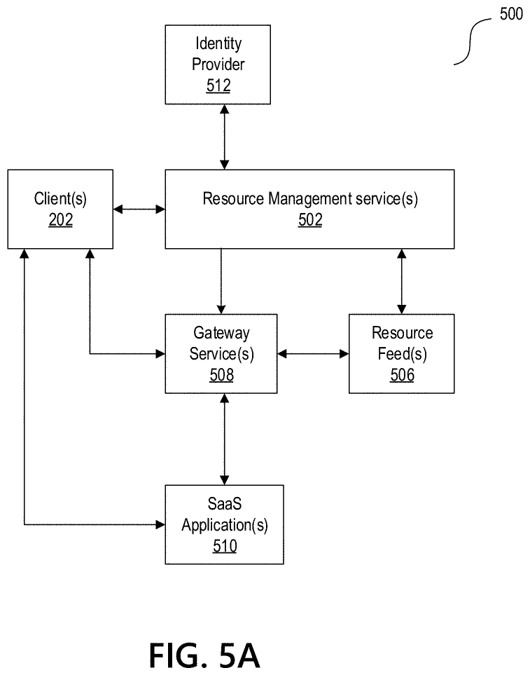

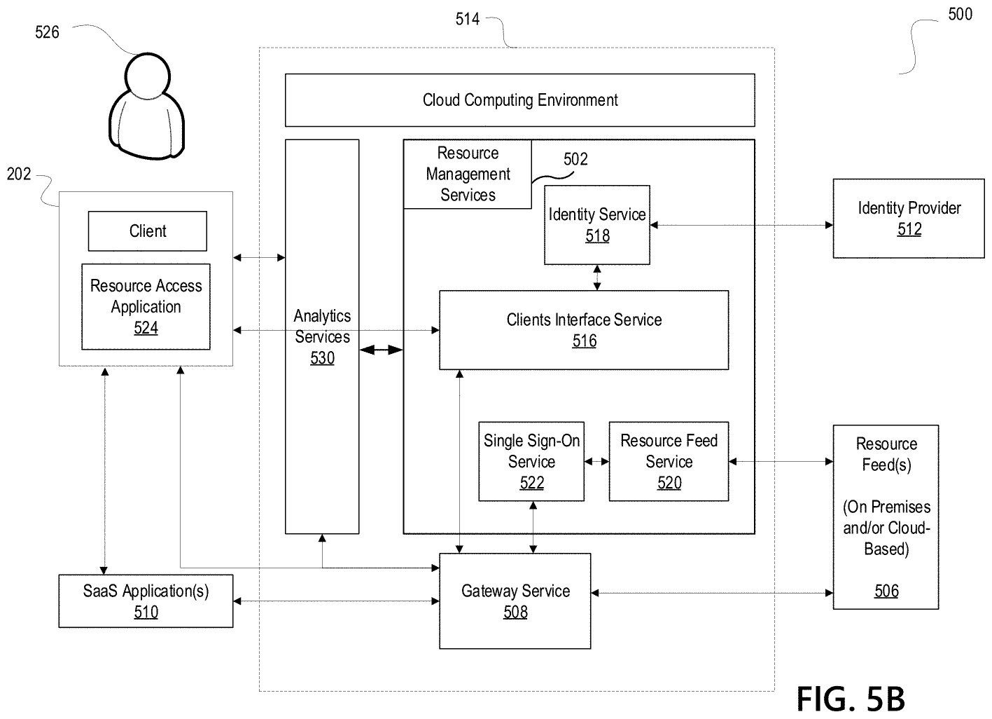

FIG. 5A is a block diagram of an example system 500 in which one or more resource management services 502 may manage and streamline access by one or more clients 202 to one or more resource feeds 506 (via one or more gateway services 508) and/or one or more software-as-a-service (SaaS) applications 510. In particular, resource management service(s) 502 may employ an identity provider 512 to authenticate the identity of a user of a client 202 and, following authentication, identify one of more resources the user is authorized to access. In response to the user selecting one of the identified resources, resource management service(s) 502 may send appropriate access credentials to requesting client 202, and client 202 may then use those credentials to access the selected resource. For the resource feed(s) 506, client 202 may use the supplied credentials to access the selected resource via a gateway service 508. For SaaS application(s) 510, client 202 may use the credentials to access the selected application directly.

The client(s) 202 may be any type of computing devices capable of accessing the resource feed(s) 506 and/or the SaaS application(s) 510, and may, for example, include a variety of desktop or laptop computers, smartphones, tablets, etc. The resource feed(s) 506 may include any of numerous resource types and may be provided from any of numerous locations. In some embodiments, for example, the resource feed(s) 506 may include one or more systems or services for providing virtual applications and/or desktops to the client(s) 202, one or more file repositories and/or file sharing systems, one or more secure browser services, one or more access control services for the SaaS applications 510, one or more management services for local applications on the client(s) 202, one or more internet enabled devices or sensors, etc. Each of the resource management service(s) 502, the resource feed(s) 506, the gateway service(s) 508, the SaaS application(s) 510, and the identity provider 512 may be located within an on-premises data center of an organization for which the system 500 is deployed, within one or more cloud computing environments, or elsewhere.

FIG. 5B is a block diagram showing an example implementation of the system 500 shown in FIG. 5A in which various resource management services 502 as well as a gateway service 508 are located within a cloud computing environment 514. The cloud computing environment may, for example, include Microsoft Azure Cloud, Amazon Web Services, Google Cloud, or IBM Cloud.

For any of illustrated components (other than client 202) that are not based within cloud computing environment 514, cloud connectors (not shown in FIG. 5B) may be used to interface those components with cloud computing environment 514. Such cloud connectors may, for example, run on Windows Server instances hosted in resource locations and may create a reverse proxy to route traffic between the site(s) and cloud computing environment 514. In the illustrated example, the cloud-based resource management services 502 include a client interface service 516, an identity service 518, a resource feed service 520, and a single sign-on service 522. As shown, in some embodiments, client 202 may use a resource access application/platform 524 to communicate with client interface service 516 as well as to present a user interface on the client 202 that a user 526 can operate to access resource feed(s) 506 and/or SaaS application(s) 510. Resource access application 524 may either be installed on client 202, or may be executed by client interface service 516 (or elsewhere in system 500) and accessed using a web browser (not shown in FIG. 5B) on client 202.

As explained in more detail below, in some embodiments, resource access application 524 and associated components may provide user 526 with a personalized, all-in-one interface, enabling instant and seamless access to all the user's SaaS and web applications, files, virtual Windows applications, virtual Linux applications, desktops, mobile applications, Citrix Virtual Apps and Desktops™, local applications, and other data.

When resource access application 524 is launched or otherwise accessed by user 526, client interface service 516 may send a sign-on request to identity service 518. In some embodiments, identity provider 512 may be located on the premises of the organization for which system 500 is deployed. Identity provider 512 may, for example, correspond to an on-premises Windows Active Directory. In such embodiments, identity provider 512 may be connected to cloud-based identity service 518 using a cloud connector (not shown in FIG. 5B), as described above. Upon receiving a sign-on request, identity service 518 may cause the resource access application 524 (via client interface service 516) to prompt user 526 for the user's authentication credentials (e.g., user-name and password). Upon receiving the user's authentication credentials, client interface service 516 may pass the credentials along to identity service 518, and identity service 518 may, in turn, forward them to identity provider 512 for authentication, for example, by comparing them against an Active Directory domain. Once identity service 518 receives confirmation from identity provider 512 that the user's identity has been properly authenticated, client interface service 516 may send a request to resource feed service 520 for a list of subscribed resources for user 526.

In other embodiments (not illustrated in FIG. 5B), identity provider 512 may be a cloud-based identity service, such as a Microsoft Azure Active Directory. In such embodiments, upon receiving a sign-on request from client interface service 516, identity service 518 may, via client interface service 516, cause client 202 to be redirected to the cloud-based identity service to complete an authentication process. The cloud-based identity service may then cause client 202 to prompt user 526 to enter the user's authentication credentials. Upon determining the user's identity has been properly authenticated, the cloud-based identity service may send a message to resource access application 524 indicating the authentication attempt was successful, and resource access application 524 may then inform the client interface service 516 of the successfully authentication. Once the identity service 518 receives confirmation from client interface service 516 that the user's identity has been properly authenticated, client interface service 516 may send a request to resource feed service 520 for a list of subscribed resources for user 526.

For each configured resource feed, resource feed service 520 may request an identity token from the single sign-on service 522. Resource feed service 520 may then pass the feed-specific identity tokens it receives to the points of authentication for respective resource feeds 506. Each resource feed 506 may then respond with a list of resources configured for the respective identity. Resource feed service 520 may then aggregate all items from the different feeds and forward them to client interface service 516, which may cause resource access application 524 to present a list of available resources on a user interface of client 202. The list of available resources may, for example, be presented on the user interface of client 202 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., ShareFile®, one or more secure browsers, one or more internet enabled devices or sensors, one or more local applications installed on client 202, and/or one or more SaaS applications 510 to which user 526 has subscribed). The lists of local applications and SaaS applications 510 may, for example, be supplied by resource feeds 506 for respective services that manage which such applications are to be made available to user 526 via resource access application 524. Examples of SaaS applications 510 that may be managed and accessed as described herein include Microsoft Office 365 applications, SAP SaaS applications, Workday applications, etc.

For resources other than local applications and SaaS application(s) 510, upon user 526 selecting one of the listed available resources, resource access application 524 may cause client interface service 516 to forward a request for the specified resource to resource feed service 520. In response to receiving such a request, resource feed service 520 may request an identity token for the corresponding feed from the single sign-on service 522. The resource feed service 520 may then pass the identity token received from single sign-on service 522 to client interface service 516 where a launch ticket for the resource may be generated and sent to resource access application 524. Upon receiving the launch ticket, resource access application 524 may initiate a secure session to gateway service 508 and present the launch ticket. When gateway service 508 is presented with the launch ticket, it may initiate a secure session to the appropriate resource feed and present the identity token to that feed to seamlessly authenticate user 526. Once the session initializes, client 202 may proceed to access the selected resource.

When user 526 selects a local application, resource access application 524 may cause the selected local application to launch on client 202. When user 526 selects a SaaS application 510, resource access application 524 may cause client interface service 516 request a one-time uniform resource locator (URL) from gateway service 508 as well a preferred browser for use in accessing SaaS application 510. After gateway service 508 returns the one-time URL and identifies the preferred browser, client interface service 516 may pass that information along to resource access application 524. Client 202 may then launch the identified browser and initiate a connection to the gateway service 508. Gateway service 508 may then request an assertion from single sign-on service 522. Upon receiving the assertion, gateway service 508 may cause the identified browser on client 202 to be redirected to the logon page for identified SaaS application 510 and present the assertion. The SaaS may then contact gateway service 508 to validate the assertion and authenticate user 526. Once the user has been authenticated, communication may occur directly between the identified browser and selected SaaS application 510, thus allowing user 526 to use client 202 to access selected SaaS application 510.

In some embodiments, the preferred browser identified by the gateway service 508 may be a specialized browser embedded in resource access application 524 (when the resource application is installed on client 202) or provided by one of resource feeds 506 (when resource application 524 is located remotely), e.g., via a secure browser service. In such embodiments, SaaS applications 510 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with client 202 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of resource feed(s) 506) for assessment of its security risk by a web filtering service. For approved URLs, the specialized browser may be permitted to access the link. For suspicious links, however, the web filtering service may have client interface service 516 send the link to a secure browser service, which may start a new virtual browser session with client 202, and thus allow the user to access the potentially harmful linked content in a safe environment.

In some embodiments, in addition to or in lieu of providing user 526 with a list of resources that are available to be accessed individually, as described above, user 526 may instead be permitted to choose to access a streamlined feed of event notifications and/or available actions that may be taken with respect to events that are automatically detected with respect to one or more of the resources. This streamlined resource activity feed, which may be customized for each user 526, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to each event right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to client 202 to notify user 526 of something that requires the user's attention (e.g., approval of an expense report, new course available for registration, etc.).

Cloud computing environment 514 may also comprise analytics services 530. Analytics services 530 may receive user usage information via resource access application 524, resource management services 502, and/or gateway service 508. Analytics services 530 may then analyze the user usage information to determine how users interact with the services provided by, for example, resource feeds 506. Analytics services 530 may also receive other information that may affect the user experience when interacting with the services. Further, analytics services 530 may perform appropriate actions based on the analysis of the received information. For example, analytics services 530 may cause output of one or more user interfaces for administrators and/or client 202. The user interfaces may comprise the analysis of the usage information of the services, and may provide (e.g., recommend) suitable policies for the users. Additional details of analytics services 530 will be described below.

Heuristic Policy Recommendations in a Virtual Environment

Aspects of the present disclosure describe heuristic and automated policy recommendations in a virtual environment. In some examples, aspects of the present disclosure describe an automated policy determination, selection, and recommendation process for users using virtual resources (e.g., resources provided by resource feed 506). For example, some aspects of the present disclosure describe obtaining (e.g., capturing, collecting, fetching) user experience metrics (e.g., heuristics data), environment configurations of the virtual resources, and the existing policies for users. Based on the obtained data, the user groups that use the virtual resources in a similar manner may be identified and the right policy sets may be recommended for the user groups.

As illustrated in greater detail below, some aspects of the disclosure may provide technical benefits that are not provided by conventional systems. For example, one or more aspects of the disclosure may automatically determine and configure new policies, and/or update the current policies for the users without any intervention of system administrators. In another example, one or more aspects of the disclosure may recommend suitable policies (e.g., new or updated policies) for the users to the system administrators, which may ease the burden on the human input to configure the right policies for each user or user group. System administrators might not need to have a deep understanding of the virtualization stack and the technical details to configure the suitable policies for specific users or user groups, which may increase the learning curve for the system administrators. In addition, suitable policies may be applied to the users or user systems in a shorter amount of time compared to manual configuration, which improves the user experience in using the resources. Various other technical benefits may be achieved as well.

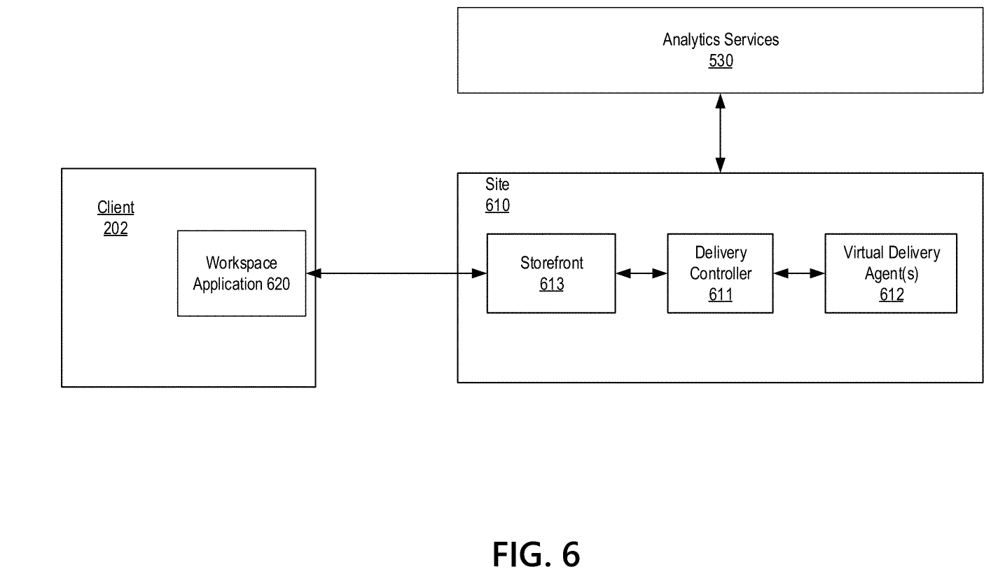

FIG. 6 depicts a schematic diagram showing an example system 600 for obtaining user experience information that may be used in accordance with one or more illustrative aspects described herein. Referring to FIG. 6, system 600 may comprise a site 630, a workspace application 620, and analytics services 530. The user experience information may comprise user experience usage information, the currently applied user experience policies, and/or system settings for one or more users.

Workspace application 620 may be a software platform that allows users to remotely access and use virtual resources (e.g., a virtual desktop, a virtual application). Some details of an example of a workspace application 620 (e.g., in system 500) have been described in connection with FIGS. 5A and 5B. Workspace application 620 may receive (e.g., retrieve) resources via, for example, resource access application 524, which may enable instant and seamless access to all the resources.

Site 610 may be a remote server (e.g., a region, resource management services 502) that manages and controls one or more delivery controllers 611, virtual delivery agents (VDA) 612, and one or more stores 613. Site 610 may establish a connection (e.g., a wireless connection) with workspace application 620 and analytics services 530.

Delivery controller 611 may be a central management component of site 610. Site 610 may have one or more delivery controllers 611 that are installed, for example, on one or more servers. Delivery controller 611 may manage the delivery of virtual resources to the client devices (e.g., client 202). For example, delivery controller 611 may distribute virtual applications and desktops to the users, authenticate and manage user access to site 610, and/or broker connections between users and the virtual desktops and applications. The virtual applications and desktops may be provided by, for example, resource feed 506. Delivery controller 611 may track which users are logged into site 610 and may track what resources are used by the users in which sessions. A session may be interactive information interchange between site 610 and user for a period of time. For example, a virtual application session may be established communication between a virtual application and a user for a period of time.

Delivery controller 611 may obtain (e.g., fetch, collect) the currently applied user experience policies for one or more users. A policy may be defined as one or more conditions that, once met, cause certain action(s) to be performed. A policy may also be a rule that defines or controls the use of virtual resources. The currently applied user experience policies may comprise one or more of: overall session bandwidth limit associated with the resources, legacy graphics mode associated with the resources (e.g., enabled or disabled), video codec for compression associated with the resources (e.g., use when available, do not use), target frame rate associated with the resources (e.g., 12 frames per second (fps), 16 fps, 30 fps), target minimum frame rate associated with the resources (e.g., 8 fps, 10 fps), a preferred or maximum color depth associated with the resources (e.g., 14 bits per pixel (bpp), 16 bpp, 24 bpp), a moving image compression status associated with the resources, video quality for the resources associated with the resources (e.g., 480p, 720p, 1080p), visual quality associated with the resources (e.g., high, low, medium), audio quality associated with the resources (e.g., low, medium, high), printer-related settings associated with the resources, a display memory limit associated with the resources, and/or user interface settings associated with the resources. Delivery controller 611 may also obtain other types of currently applied user experience policies for the one or more users.

The user interface settings may comprise desktop composition redirection associated with the resources (e.g., enable or disable the use of graphics processing unit (GPU) or integrated graphics processor (IGP) on the user device for rendering local graphics), desktop wall paper status associated with the resources (e.g., allowed, prohibited), and/or menu animation status associated with the resources (e.g., allowed, prohibited).

The visual quality for the resources may control the visual quality of images displayed on the user device, and may be set as medium, high, always lossless, or build to lossless (e.g., the default visual quality may be medium). The visual quality may be set based on the available bandwidth for the resources.

The target frame rate may specify the maximum number of frames per second that are sent from a virtual desktop or application to a user device (e.g., the default target frame rate may be 30). For devices that have slower CPUs, specifying a lower value of the target frame rate may improve the user experience. The maximum supported frame rate per second may be set to be 60 fps or 120 fps.

The display memory limit may specify the maximum video buffer size for a session (e.g., the default display memory limit may be 65,536 KB). For connections requiring more color depth and higher resolution, the display memory limit may be increased to improve the user experience.

Delivery controller 611 may obtain the currently applied user experience policies via gateway services 508. For example, gateway services 508 may fetch the currently applied user experience policies and send the policies to delivery controller 611. Additionally or alternatively, delivery controller 611 may obtain the currently applied user experience policies via a database associated with site 610. For example, delivery controller 611 may query the database for policies associated with a specific user or user group, and/or policies associated with a specific virtual resource. Site 610 may store the currently applied user experience policies for one or more users or user groups in a database accessible by site 610. The database may be constantly updated based on whether new policies are determined and applied to the users or user groups. The database may also store resource configuration information and session information.

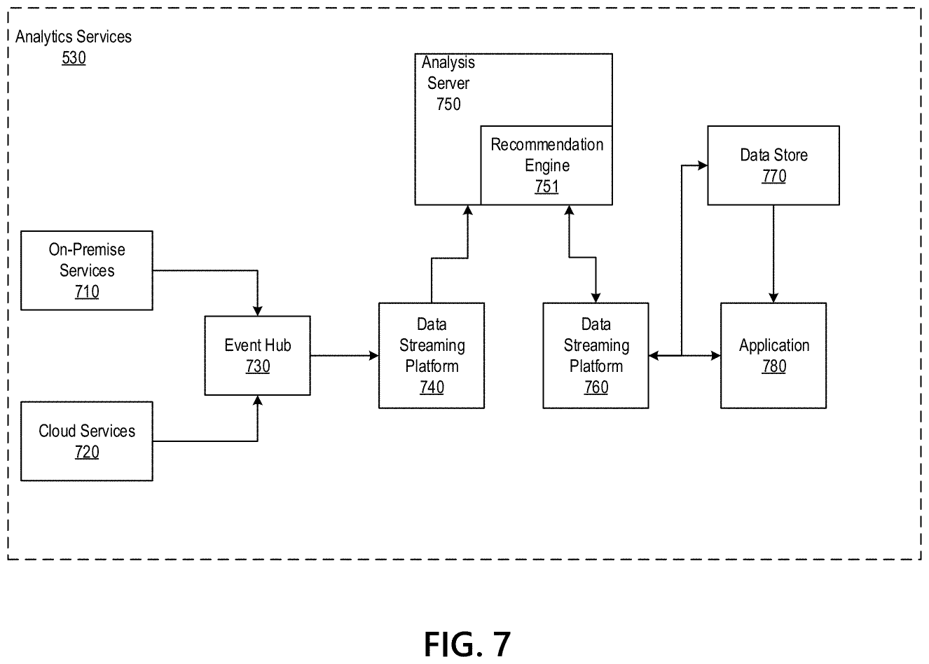

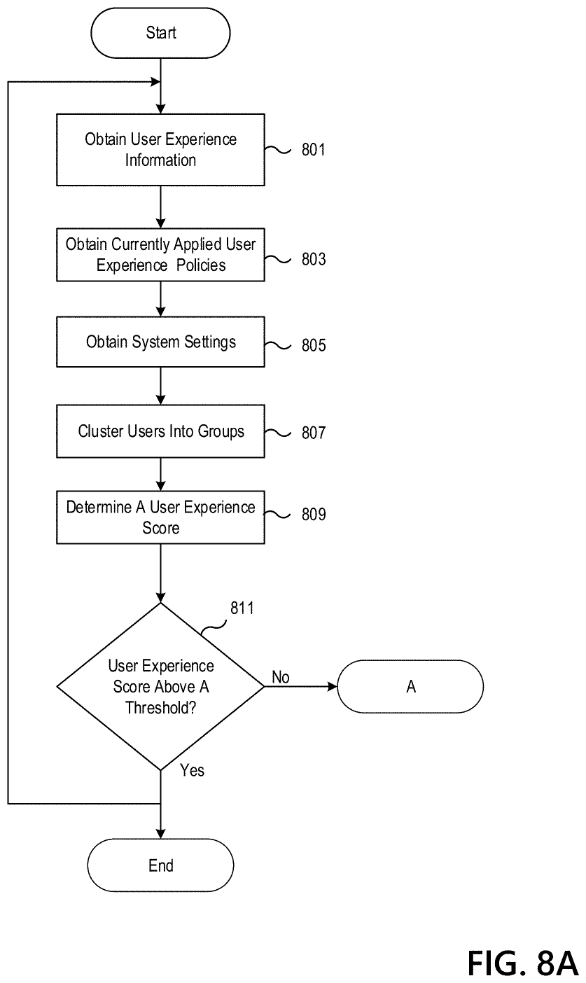

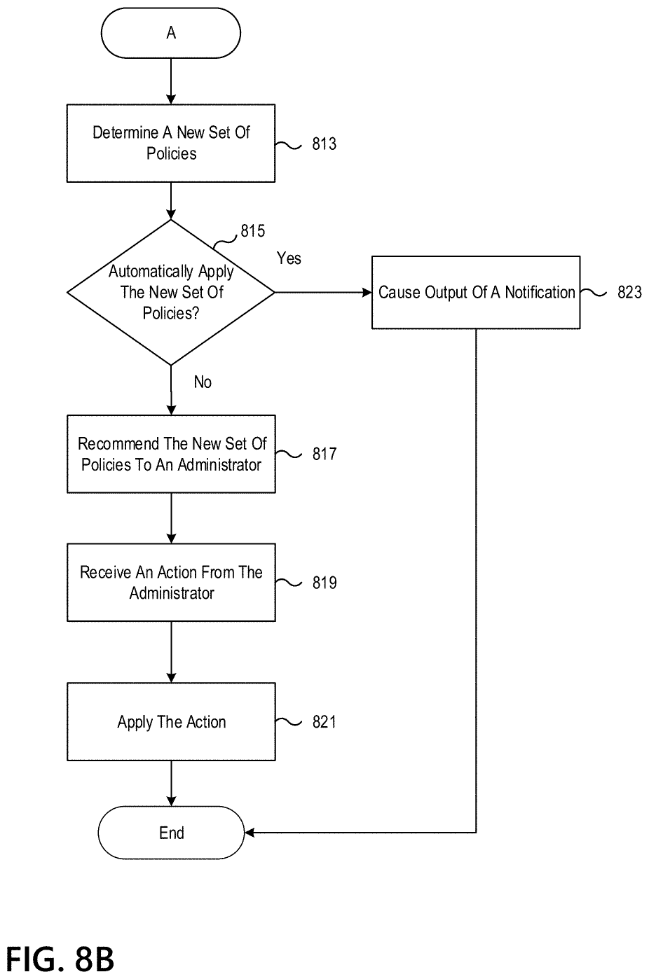

Delivery controller 611 may send the currently applied user experience policies to analytics services 530. Analytics services 530 may receive and analyze the currently applied user experience policies for the users. Additional details of analytics services 530 will be described in connection with FIGS. 7, 8A, and 8B.

The collection of the currently applied user experience policies may be performed in each session, or may be performed periodically at a regular interval (e.g., every day, every week, every month). The currently applied user experience policies may also be obtained by other devices, components, and/or modules associated with site 610 and/or cloud computing environment 514.

VDA 612 may be installed on a physical or virtual machine in site 610. The VDA may enable the machine to register with delivery controller 611, which may in turn allow the machine and the resources to be made available to users. VDA 612 may establish and manage the connection between the machine and the user devices (e.g., client 202). VDA 612 may register with a cloud connector and connections between site 610 and the user device may be brokered from resources to users after registration. VDA 612 may also establish and manage the connections and apply policies that are configured for each application session. VDA 612 may be installed on server or desktop machines within a data center for delivery methods to user devices located outside the data center. VDA 630 may also be installed on physical PCs for remote PC access, such as remote PC access to machine 632 from user device 601. VDA 612 may comprise application virtualization software such as XENAPP® or XENDESKTOP®. Each VDA 612 may be associated with one session or multiple sessions. An application session may begin when a user starts an application (e.g., the user tries to access an application) and may end when the application exits or when the user exits workspace application 620.

VDA 612 may obtain (e.g., fetch, collect) user experience usage information (e.g., statistics, metrics) for one or more users. The user experience usage information may affect the user experience when using the resources. The user experience usage information associated with one user may comprise one or more of: the bandwidth consumption for using the resources (e.g., low, medium, or high), the frame rate associated with the resources, the user input delay associated with the resources (e.g., a time elapsed from when a user hits key until a response is received by the site 610), a duration of time needed for a keystroke to appear), the latency associated with the resources (e.g., a time elapsed for a resource to appear or launch after a keystroke), a number of failures associated with the resources (e.g., a number of times that the session or resource fails to launch or deliver), a round trip time (RTT) associated with the resources (e.g., a time elapsed from when a user hits a key until the response is displayed back at an end point), the transport protocol used for delivering the resources (e.g., transmission control protocol (TCP), user datagram protocol (UDP), enlightened data transport (EDT) protocol). VDA 612 may also obtain other types of user experience usage information.

VDA 612 may obtain user experience usage information in a data payload format. A non-exhaustive list of example data payload obtained by VDA 612 may be shown in Table 1 below:

TABLE 1

| Session ID | 992d0a07-6417-46f5-b4e8-eda1998d712c | |
|---|---|---|
| Event Time | 11/23/2020 12:28:46 | |
| Machine Name | AW001-TSVDA | |
| SiteName | BLR-LAB | |
| RTT | 23 | seconds |
| Input Bandwidth Used | 156 | Mbps |
| Frame Rate | 30 | fps |

VDA 612 may obtain the user experience usage information via gateway services 508. For example, gateway services 508 may fetch the user experience usage information and send the information to VDA 612. As another example, when a user starts an application session, VDA 612 may trigger a network bandwidth test for the user. VDA 612 may communicate with one or more nodes associated with workspace application 620 to obtain the network bandwidth for the users or user groups. The bandwidth associated with site 610 during a session may be measured based on software tools such as Iperf, which may generate data streams (e.g., network data packets) to measure the network bandwidth between two nodes (e.g., site 610 and workspace application 620) in one or both directions. Additionally or alternatively, VDA 612 may obtain the user experience usage information via a database associated with site 610. VDA 612 may send the user experience usage information to analytics services 530.

The collection of the user experience usage information may be performed in each session, or may be performed periodically at a regular interval (e.g., every day, every week, every month). The user experience usage information may also be obtained by other devices, components, and/or modules associated with site 610 and/or cloud computing environment 514.

Storefront 613 may authenticate users and/or user devices, and manage stores of the resources that users may access. Storefront 613 may host one or more application stores, which gives users self-service access to the available desktops and applications. Storefront 613 may also keep track of users' application subscriptions, shortcut names, and other data, which may ensure that users have a consistent and better experience across multiple devices.

Site 610 may obtain (e.g., collect, fetch) system settings (e.g., application settings), for example, associated with workspace application 620. The application settings may comprise, for example, hardware acceleration for graphics (e.g., enabled, disabled), and/or decoding parameters for graphics (e.g., whether H.265 decoding is enabled, disabled, supported, or not supported; types of decoding techniques). Hardware acceleration for graphics may refer to using a computer's hardware to perform graphics functions associated with the resources (e.g., workspace application 620). H.265 decoding for graphics may refer to using H.265 compression techniques for decoding graphics associated with the resources. The system settings may be fetched by VDA 612. VDA 612 may be installed on a client machine (e.g., client machine 240) and may fetch the details of the client machine from registry, Windows management instrumentation (WMI), etc. Depending on the system settings, the new policies may be curated for the requirements. For example, if the hardware acceleration for graphics is enabled, then the appropriate encoding methods may be chosen. Site 610 may also obtain other types of system settings. The collection of the system settings may be performed in each session, or may be performed periodically at a regular interval (e.g., every day, every week, every month). The system settings may also be obtained by one or more devices, components, and/or modules associated with site 610 and/or cloud computing environment 514.

FIG. 7 depicts a schematic diagram showing an example system for providing heuristic and automated policy recommendations in a virtual environment that may be used in accordance with one or more illustrative aspects described herein. In FIG. 7, analytics services 530 may comprise a plurality of components such as on-premises services 710, cloud services 720, an event hub 730, a data streaming platform 740, an analysis server 750, a data streaming platform 760, a data store 770, and an application 780. Each of the components comprised in analytics services 530 may be a program module, executed by one or more computers or other devices as described herein, or a computing device that comprises one or more modules. Analytics services 530 may comprise other components and/or modules that facilitate the processing and/or the analysis of the data.

On-premises services 710 may comprise virtual on-premise application and desktop services. On-premises services 710 may receive data obtained by site 610 (e.g., data obtained by delivery controller 611 and/or VDA 612) in real-time. On-premises services 710 may also monitor services performed by delivery controller 611 and/or VDA 612 and track the data stored in site 610.

Cloud services 720 may comprise virtual cloud application and desktop services. Cloud services 720 may receive data obtained by site 610 (e.g., data obtained by delivery controller 611 and/or VDA 612) in real-time. Cloud services 720 may also monitor services performed by delivery controller 611 and/or VDA 612 and track the data stored in site 610.

Event hub 730 may be a data streaming and ingestion platform (e.g., an Azure event hub). Event hub 730 may receive (e.g., ingest) the data sent from on-premises services 710 and cloud services 720 in real-time, and then buffer the received data. Event hub 730 may be implemented as a cloud service accessible by analytics services 530 or other devices/services. Event hub 730 may automatically scale up throughput units depending on the needs of analytics services 530. Event hub 730 may process (e.g., partition) the received data in an efficient manner and send the data to a data streaming platform (e.g., data streaming platform 740, a message queue).

Data streaming platform 740 may be a stream-processing software platform (e.g., a message broker, a message queue, Apache Kafka). Data streaming platform 740 may perform an extract, transform, load (ETL) process on the data received by event hub 730. Data streaming platform 740 may extract (e.g., receive) data from event hub 730 in real-time as event hub 730 receives data from the sources (e.g., on-premises services 710, cloud services 720), and transform the received data into suitable structures and formats for analysis and querying. For example, data streaming platform 740 may extract batches (e.g., payloads) of data from event hub 730 and categorize (e.g., divide) the data into different categories. Data streaming platform 740 may extract all the relevant data (e.g., user experience usage information, currently applied user experience policies, system settings) for one user and transform that data into proper formats or structures based on the requirements set by analytics services 530. Data streaming platform 740 may determine and transform multiple groups of data based on different factors (e.g., users, user groups, location of the users, delivery groups of the services, sites used by the users). Data streaming platform 740 may load the transformed data to analysis server 750. For example, data streaming platform 740 may send one or more groups of data of different factors to analysis server 750.

Analysis server 750 may be an analytics engine (e.g., Apache Spark) for large-scale data processing. Analysis server 750 may provide an interface for programming/processing a plurality of sets of data items that are distributed over a cluster of machines. Analysis server 750 may receive the data sent from data streaming platform 740.

Analysis server 750 may analyze the data and cluster users (e.g., client 202) associated with a plurality of user devices into user groups based on the characteristics of the data. For example, analysis server 750 may analyze the user experience usage information across a number of users and sessions. Analysis server 750 may also analyze the user experience usage information in multiple dimensions such as sites (e.g., site 610), locations (e.g., cities, countries), delivery groups (e.g., engineering group of a company may demand better audio/video policies compared to other groups of the company), and time (e.g., morning, afternoon, evening) for the users. Analysis server 750 may cluster the users based on the analysis of the user experience usage information. Users that share similar characteristics of the user experience usage information may be clustered into the same group. For example, Users associated with similar bandwidth consumptions may be grouped together. In another example, users associated with similar frame rates may be grouped together. In another example, users that belong to the same department in a company may be grouped together.

Analysis server 750 may determine (e.g., set) the thresholds for clustering the users. Analysis server 750 may determine a maximum bandwidth usage, a minimum bandwidth usage, and/or an average bandwidth usage for a period of time, and may determine a bandwidth usage graph based on the time for each user. Users that share similar bandwidth usage graphs may be clustered. Different methods or algorithms may be used to determine the similarity of the bandwidth usages among the users. One or more thresholds more be set for determining whether the users share similar levels of user experience usage information. For example, if a user's maximum bandwidth consumption is above a first threshold (e.g., 400 Mbps), the user may be clustered into a high bandwidth group. If a user's maximum bandwidth consumption is above a second threshold (e.g., 100 Mbps), but below the first threshold, the user may be clustered into a medium bandwidth group. If a user's maximum bandwidth consumption is above a third threshold (e.g., 50 Mbps), but below the second threshold, the user may be clustered into a low bandwidth group. A user's minimum bandwidth consumption and/or average bandwidth consumption may also be used to determine the similarities among the users' bandwidth consumptions.

Analysis server 750 may cluster the users based on the locations of the users. For example, if users are employees of a company, employees from the same office (e.g., branch, location, department) of the company may be clustered into one user group because they are more likely to have similar network usage or perform similar tasks. In another example, users that are in the same region (e.g., city, country) may be clustered into one user group.

Because the user experience usage information may constantly change in a session, analysis server 750 may build a model for mapping the relationship between the time and a user experience factor (e.g., bandwidth consumption). To determine the similarities of user experience usage information among the users, analysis server 750 may conduct time series analysis such as dynamic time warping. Other methods of determining the similarities of the user experience usage information such as deep learning may also be used.

Users may be clustered into more than one group. For example, a user may be clustered into a high-bandwidth group and a high visual quality group. In some examples, a user may be clustered into only one group due to, for example, conflicts in settings for different groups. Analysis server 750 may have predetermined rules that set the priority of different groups or determine a best-case match based on the affiliation of the user to a cluster. Analysis server 750 may select one of the groups for the users based on factors such as bandwidth consumption, which may be determined to be more important to the user.

Analysis server 750 may determine (e.g., calculate) a user experience score for each user. Analysis server 750 may determine the user experience scores based on the user experience usage information, the currently applied user experience policies, and/or the system settings. Analysis server 750 may build one or more models (e.g., statistical models) for determining the user experience scores. Some factors in the user experience usage information may have a greater impact on the user experience scores than other factors. For example, a user input delay may greatly affect the user experience.

Analysis server 750 may determine a plurality of levels of user experience based on the user experience scores. For example, if a user experience score is above a first threshold, analysis server 750 may determine that the user experience level is excellent. If a user experience score is above a second threshold, but below the first threshold, analysis server 750 may determine that the user experience level is good. If a user experience score is below the second threshold, analysis server 750 may determine that the user experience level is poor.

Analysis server 750 may determine the user experience score for each user session and/or at a regular interval (e.g., every 15 minutes, every 30 minutes). Analysis server 750 may determine whether there is a drastic change in the user experience score (e.g., the user experience is at a different level). If there is a drastic change in the user experience score, analysis server 750 may determine to reevaluate whether the existing policies for the users need to be updated.

Analysis server 750 may determine policies for the users based on the determined user experience level. For example, if the user experience level is excellent, analysis server 750 might not apply or recommend new policies for the user. If the user experience level is good or poor, analysis server 750 may determine new policies that may improve the user experience. Analysis server 750 may automatically apply the new policies for the user, or recommend the new policies to a system administrator so that the system administrator may decide whether to apply the new policies for the user.

Analysis server 750 may comprise a recommendation engine 751. If analysis server 750 determines that a new set of policies need to be recommended or applied to a user or a user group, recommendation engine 751 may provide policy recommendations for each user or user group based on the analysis of the user experience information. Recommendation engine 751 may determine the user groups on which the policies may be applied and the set of policies that are to be applied to the determined user groups. The set of policies that are to be applied to the determined user groups may optimize the user experience for the users in the user groups.

The policies may be recommended based on the user experience information analyzed in the user environment for every user group identified. For example, if the determined available bandwidth is very low, the recommendation engine 750 may recommend policies that might not consume a large amount of bandwidth. For example, recommendation engine 751 may recommend policies that set the preferred color depth to be 8 bit, enable moving image compression, and/or set the visual quality to be low.

Analysis server 750 may store the user experience usage information, currently applied user experience policies, system settings, user experience scores, and/or the determined new policies in one or more databases (e.g., data store 770). Analysis server 750 may store the data in data store 770 via a data streaming platform 760. Data streaming platform 760 may be a stream-processing software platform (e.g., a message broker, a message queue, Apache Kafka). Data streaming platform 760 may use one or more queues for processing the data and/or passing the data from the analysis server 750 to data store 770. Data streaming platform 760 may group messages/data together to reduce the overhead of the network roundtrip when passing the data from the analysis server 750 to data store 770.

Data store 770 may be a database located in analytics services 530 or in another computing device accessible by analytics services 530. Data store 770 may be a distributed data store (e.g., Apache Druid) that may ingest a large quantity of data, and provide low-latency queries for the data. Analysis server 750 may query data store 770 for previous and/or current user experience usage information, previously and/or currently applied user experience policies, previous and/or current system settings, and/or previous and current user experience scores. For example, to determine a trend of user experience usage information (e.g., user bandwidth consumption), analysis server 750 may query data store 770 for that information. Data store 770 may also be accessed by administrators that desire to obtain information associated with the users.

Based on determining a new set of policies for a user or a user group, analysis server 750 may send the new set of policies to an application 780. Analysis server 750 may send the new set of policies directly to application 780, or via data streaming platform 760. Application 780 may also query data store 770 for the new set of policies.

Application 780 may comprise one or more user interfaces that output the new set of policies. For example, application 780 may comprise a user interface that provides options for applying, declining, and/or modifying the new set of policies. The user interface may also comprise other information related to the new set of policies (e.g., the user or the user groups to whom the new set of policies may be applied, user experience scores). The user interface may comprise user information such as a user name, a location of the user, an entity associated with the user (e.g., user's employer). The user interface may allow the application of the new set of policies at a specific time or for a particular time period. The user interface may be output to an administrator, and the administrator may choose to apply, decline, or modify the new set of policies. Application 780 may also automatically apply the new set of policies without any action performed by the administrator based on predetermined rules set by application 780 or the administrator, after a new set of policies for a user or a user group are determined.

FIGS. 8A and 8B depict a flowchart showing an example method for providing heuristic and automated policy recommendations in a virtual environment in accordance with one or more illustrative aspects described herein. The example method may be performed, for example, by one or more computing devices such as cloud computing environment 514, analytics services 530, and/or site 610. The steps of the example method are described as being performed by particular computing devices for the sake of simplicity, but the steps may be performed by any other computing device.

In FIG. 8A, at step 801, a computing device may obtain user experience usage information. The user experience usage information may comprise a bandwidth consumption for using the resources, a frame rate associated with the resources, a user input delay associated with the resources, a latency associated with the resources, a number of failures associated with the resources, a round trip time (RTT) associated with the resources, and/or a transport protocol used for the resources. Additional and other types of user experience usage information may also be obtained by the computing device.

At step 803, the computing device may obtain currently applied user experience policies (e.g., existing policies). The currently applied user experience policies may be the rules or actions applied to one or more applications that the user has used or is using. The currently applied user experience policies may comprise one or more of: an overall session bandwidth limit, a legacy graphics mode, a video codec for compression, a target frame rate, a target minimum frame rate, a preferred or maximum color depth for the virtual resources, a moving image compression status for the resources, video quality for the resources, visual quality for the resources, audio quality for the resources, printer-related settings for the resources, a display memory limit, and/or user interface settings for the resources. Additional and other types of user experience policies may also be obtained by the computing device.

At step 805, the computing device may obtain system settings. The system settings may comprise, for example, hardware acceleration for graphics, and/or decoding parameters for graphics. Additional and other types of system settings may also be obtained by the computing device.

At step 807, the computing device may cluster users into groups. The computing device may cluster, based on user experience usage information, currently applied user experience policies, and/or system settings, the users into one or more user groups. The computing device may compare the user experience usage information based on factors such as sites, locations, delivery groups, and/or time among the users. The computing device may then determine one or more rules for clustering the users based on the comparison. For example, users that share similar levels of user experience usage information such as average bandwidth consumption may be clustered into one group.

At step 809, the computing device may determine a user experience score. Based on the obtained information, the computing device may determine a user experience score that measures the user experience when using the virtual service. The user experience score may be compared against one or more thresholds, and each threshold may indicate a level of user experience.

At step 811, the computing device may determine whether the user experience score is above a threshold. The computing device may determine whether the currently applied user experience policies need to be updated and/or reconfigured based on whether the user experience score is above the threshold. If the user experience score is above a threshold, the computing device may determine that the currently applied user experience policies do not need to be updated and/or reconfigured.

Referring to FIG. 8B, at step 813, the computing device may determine a new set of policies if the user experience score is not above a threshold. For example, the computing device may determine a new set of policies (e.g., an updated set of policies) based on the user experience usage information, the currently applied user experience policy, and/or the system settings. The new set of policies may improve the user experience for using the virtual service. The determined set of policies may be stored in a database (e.g., data store 770).

At step 815, the computing device may determine whether to automatically apply the new set of policies. For example, the computing device may determine whether to automatically apply the new set of policies to the corresponding user or user groups based on a rule set by the administrator or the user.

At step 817, the computing device may recommend the new set of policies to an administrator, for example, if the computing device determines not to automatically apply the new set of policies. The computing device may comprise a user interface that outputs the new set of policies. The user interface may also comprise options that allow an administrator to apply, decline, and/or modify the new set of policies.

At step 819, the computing device may receive an action from the administrator. After the administrator chooses to apply, decline, and/or modify the new set of policies, the computing device may receive a corresponding action (e.g., an indication) from the administrator.

At step 821, the computing device may apply the action. For example, if the administrator chooses to apply the new set of policies, the computing device may apply the new set of policies for the corresponding user or user group. If the administrator chooses to decline the new set of policies, the computing device might not apply the new set of policies for the corresponding user or user group, and may continue to use the previous (e.g., existing) policies for the corresponding user or user group.

At step 823, the computing device may cause the output of the notification. The notification may be output to an administrator and/or a user. For example, the notification may be output via a user interface (e.g., a workspace user interface on workspace application 620) on a user device. The notification may be output to the administrator via a different user interface on a different user device. The administrator may modify or undo the applied the new set of policies.

The above steps may be performed and/or repeated in one or more user sessions associated with a virtual service. The computing device may perform one or more of the above steps at a regular interval or every session. In this way, the user experience policies may be constantly updated to improve the user experience, with minimal human intervention or without any human input.

The following paragraphs (M1) through (M8) describe examples of methods that may be implemented in accordance with the present disclosure.

(M1) A method comprising: obtaining, by a computing device and from a plurality of user devices, usage information associated with a virtual service; obtaining, from the plurality of user devices, currently applied user experience policies for the virtual service; obtaining, from the plurality of user devices, system settings for the virtual service; based on the usage information, the currently applied user experience policies, and the system settings, clustering users associated with the plurality of user devices into user groups; and determining a set of new policies for each user group; and recommending the set of the new policies.

(M2) A method may be performed as described in paragraph (M1) wherein the usage information comprises at least one of: bandwidth consumption information associated with the virtual service; a frame rate associated with the virtual service; a user input delay associated with the virtual service; content output latency associated with the virtual service; or a transport protocol used associated with the virtual service.

(M3) A method may be performed as described in either paragraph (M1) or (M2) wherein the currently applied user experience policies comprise at least one of: a color depth associated with the virtual service; a moving image compression status associated with the virtual service; visual quality associated with the virtual service; audio quality associated with the virtual service; or user interface settings associated with the virtual service.

(M4) A method may be performed as described in any of paragraphs (M1) through (M3) wherein the system settings comprise at least one of: hardware acceleration for graphics associated with the virtual service; or decoding parameters for graphics associated with the virtual service.

(M5) A method may be performed as described in any of paragraphs (M1) through (M4) wherein the clustering comprises clustering, based on a location of each of the users, the users into the user groups.

(M6) A method may be performed as described in any of paragraphs (M1) through (M5) further comprising: calculating, based on the usage information, the currently applied user experience policies, and the system settings, a user experience score for a user associated with one of the plurality of user devices; and based on a determination that the user experience score is below a threshold, determining a new set of policies that optimizes the user experience score for the user.

(M7) A method may be performed as described in any of paragraphs (M1) through (M6), wherein the virtual service comprises at least one of a virtual application or a virtual desktop.

(M8) A method may be performed as described in any of paragraphs (M1) through (M7) further comprising: automatically applying the set of the new policies to users in a user group.

The following paragraphs (A1) through (A8) describe examples of apparatuses that may be implemented in accordance with the present disclosure.

(A1) An apparatus comprising one or more processors; and memory storing instructions that, when executed by the one or more processors, cause the apparatus to obtain, from a plurality of user devices, usage information associated with a virtual service; obtain, from the plurality of user devices, currently applied user experience policies for the virtual service; obtain, from the plurality of user devices, system settings for the virtual service; based on the usage information, the currently applied user experience policies, and the system settings, cluster users associated with the plurality of user devices into user groups; and determine a set of new policies for each user group; and recommend the set of the new policies.

(A2) An apparatus may be implemented as described in paragraph (A1) wherein the usage information comprises at least one of: bandwidth consumption information associated with the virtual service; a frame rate associated with the virtual service; a user input delay associated with the virtual service; content output latency associated with the virtual service; or a transport protocol used associated with the virtual service.

(A3) An apparatus may be implemented as described in paragraph (A1) or paragraph (A2) wherein the currently applied user experience policies comprise at least one of: a color depth associated with the virtual service; a moving image compression status associated with the virtual service; visual quality associated with the virtual service; audio quality associated with the virtual service; or user interface settings associated with the virtual service.

(A4) An apparatus may be implemented as described in any of paragraphs (A1) through (A3) wherein the system settings comprise at least one of: hardware acceleration for graphics associated with the virtual service; or decoding parameters for graphics associated with the virtual service.

(A5) An apparatus may be implemented as described in any of paragraphs (A1) through (A4) wherein the instructions, when executed by the one or more processors, further cause the apparatus to cluster the users by clustering, based on a location of each of the users, the users into the user groups.

(A6) An apparatus may be implemented as described in any of paragraphs (A1) through (A5) wherein the instructions, when executed by the one or more processors, further cause the apparatus to calculate, based on the usage information, the currently applied user experience policies, and the system settings, a user experience score for a user associated with one of the plurality of user devices; and based on a determination that the user experience score is below a threshold, determine a new set of policies that optimizes the user experience score for the user.

(A7) An apparatus may be implemented as described in any of paragraphs (A1) through (A6) wherein the virtual service comprises at least one of a virtual application or a virtual desktop.

(A8) An apparatus may be implemented as described in any of paragraphs (A1) through (A7) wherein the instructions, when executed by the one or more processors, further cause the apparatus to automatically apply the set of the new policies to users in a user group.

The following paragraphs (CRM1) through (CRM4) describe examples of computer-readable media that may be implemented in accordance with the present disclosure.

(CRM1) A non-transitory computer-readable medium storing instructions that, when executed, cause: obtaining, from a plurality of user devices, usage information associated with a virtual service; obtaining, from the plurality of user devices, currently applied user experience policies for the virtual service; obtaining, from the plurality of user devices, system settings for the virtual service; based on the usage information, the currently applied user experience policies, and the system settings, clustering users associated with the plurality of user devices into user groups; and determining a set of new policies for each user group; and recommending the set of the new policies.

(CRM2) A non-transitory computer-readable medium may be implemented as described in paragraph (CRM1) wherein the usage information comprises at least one of: bandwidth consumption information associated with the virtual service; a frame rate associated with the virtual service; a user input delay associated with the virtual service; content output latency associated with the virtual service; or a transport protocol used associated with the virtual service.

(CRM3) A non-transitory computer-readable medium may be implemented as described in paragraph (CRM2) wherein the currently applied user experience policies comprise at least one of: a color depth associated with the virtual service; a moving image compression status associated with the virtual service; visual quality associated with the virtual service; audio quality associated with the virtual service; or user interface settings associated with the virtual service.

(CRM4) A non-transitory computer-readable medium may be implemented as described in any of paragraphs (CRM1) through (CRM4) wherein the system settings comprise at least one of: hardware acceleration for graphics associated with the virtual service; or decoding parameters for graphics associated with the virtual service.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A method comprising:
obtaining, by a computing device and from a plurality of user devices, usage information associated with a virtual service;
obtaining, from the plurality of user devices, currently applied user experience policies for the virtual service;
obtaining, from the plurality of user devices, system settings for the virtual service;
based on the usage information, the currently applied user experience policies, and the system settings,
clustering users associated with the plurality of user devices into user groups; and
determining a set of new policies for each user group; and
recommending the set of the new policies.

2. The method of claim 1, wherein the usage information comprises at least one of:
bandwidth consumption information associated with the virtual service;
a frame rate associated with the virtual service;
a user input delay associated with the virtual service;
content output latency associated with the virtual service; or
a transport protocol used associated with the virtual service.

3. The method of claim 1, wherein the currently applied user experience policies comprise at least one of:
a color depth associated with the virtual service;
a moving image compression status associated with the virtual service;
visual quality associated with the virtual service;
audio quality associated with the virtual service; or
user interface settings associated with the virtual service.

4. The method of claim 1, wherein the system settings comprise at least one of:
hardware acceleration for graphics associated with the virtual service; or
decoding parameters for graphics associated with the virtual service.

5. The method of claim 1, wherein the clustering comprises:
clustering, based on a location of each of the users, the users into the user groups.

6. The method of claim 1, further comprising:
calculating, based on the usage information, the currently applied user experience policies, and the system settings, a user experience score for a user associated with one of the plurality of user devices; and
based on a determination that the user experience score is below a threshold, determining a new set of policies that optimizes the user experience score for the user.

7. The method of claim 1, wherein the virtual service comprises at least one of a virtual application or a virtual desktop.

8. The method of claim 1, further comprising:
automatically applying the set of the new policies to users in a user group.

9. An apparatus comprising:
one or more processors; and
memory storing instructions that, when executed by the one or more processors, cause the apparatus to:
obtain, from a plurality of user devices, usage information associated with a virtual service;
obtain, from the plurality of user devices, currently applied user experience policies for the virtual service;
obtain, from the plurality of user devices, system settings for the virtual service;
based on the usage information, the currently applied user experience policies, and the system settings,
cluster users associated with the plurality of user devices into user groups; and
determine a set of new policies for each user group; and
recommend the set of the new policies.

10. The apparatus of claim 9, wherein the usage information comprises at least one of:
bandwidth consumption information associated with the virtual service;
a frame rate associated with the virtual service;
a user input delay associated with the virtual service;
content output latency associated with the virtual service; or
a transport protocol used associated with the virtual service.

11. The apparatus of claim 9, wherein the currently applied user experience policies comprise at least one of:
a color depth associated with the virtual service;
a moving image compression status associated with the virtual service;
visual quality associated with the virtual service;
audio quality associated with the virtual service; or
user interface settings associated with the virtual service.

12. The apparatus of claim 9, wherein the system settings comprise at least one of:
hardware acceleration for graphics associated with the virtual service; or
decoding parameters for graphics associated with the virtual service.

13. The apparatus of claim 9, wherein the instructions, when executed by the one or more processors, further cause the apparatus to cluster the users by clustering, based on a location of each of the users, the users into the user groups.

14. The apparatus of claim 9, wherein the instructions, when executed by the one or more processors, further cause the apparatus to:
calculate, based on the usage information, the currently applied user experience policies, and the system settings, a user experience score for a user associated with one of the plurality of user devices; and
based on a determination that the user experience score is below a threshold, determine a new set of policies that optimizes the user experience score for the user.

15. The apparatus of claim 9, wherein the virtual service comprises at least one of a virtual application or a virtual desktop.

16. The apparatus of claim 9, wherein the instructions, when executed by the one or more processors, further cause the apparatus to:
automatically apply the set of the new policies to users in a user group.

17. One or more non-transitory computer readable media storing computer readable instructions that, when executed, cause:
obtaining, from a plurality of user devices, usage information associated with a virtual service;
obtaining, from the plurality of user devices, currently applied user experience policies for the virtual service;
obtaining, from the plurality of user devices, system settings for the virtual service;
based on the usage information, the currently applied user experience policies, and the system settings,
clustering users associated with the plurality of user devices into user groups; and
determining a set of new policies for each user group; and
recommending the set of the new policies.

18. The one or more non-transitory computer readable media of claim 17, wherein the usage information comprises at least one of:
bandwidth consumption information associated with the virtual service;
a frame rate associated with the virtual service;
a user input delay associated with the virtual service;
content output latency associated with the virtual service; or
a transport protocol used associated with the virtual service.

19. The one or more non-transitory computer readable media of claim 17, wherein the currently applied user experience policies comprise at least one of:
a color depth associated with the virtual service;
a moving image compression status associated with the virtual service;
visual quality associated with the virtual service;
audio quality associated with the virtual service; or
user interface settings associated with the virtual service.

20. The one or more non-transitory computer readable media of claim 17, wherein the system settings comprise at least one of:
hardware acceleration for graphics associated with the virtual service; or
decoding parameters for graphics associated with the virtual service.
